(19) United States
(12) Patent Application Publication
(10) Pub. No.: US 2010/0264839 A1
(43) Pub. Date: Oct. 21, 2010

(54) LOAD CONTROL DEVICE, AND LIGHTING DEVICE

(75) Inventor: Fujio Kurokawa, Nagasaki-shi (JP)

Correspondence Address: Jae Y. Park, Kile, Goekjian, Reed & McManus, PLLC, 1200 New Hampshire Ave. NW, Suite 570, Washington, DC, 20036, US

(73) Assignee: NAGASAKI UNIVERSITY, Nagasaki-shi (JP)

(21) Appl. No.: 12/739,716

(22) PCT Filed: Oct. 17, 2008
(86) PCT No.: PCT/JP2008/068842

§ 371 Date: Jul. 2, 2010

(30) Foreign Application Priority Data
Oct. 24, 2007 (JP) 2007-275952

(51) Int. Cl. H05B 41/36; H02M 7/48

(52) U.S. Cl. 315/224; 363/97

(57) ABSTRACT

Provided is a discharge lamp lighting device, which can control a load precisely while improving the practicability. When the difference of a count number (Nn) becomes a predetermined threshold value or less, a predictor circuit (35) predicts the timing, at which a current value (iQ1) becomes a peak value, on the basis of the rate of change of the difference. A switch selecting circuit (38), which is driven with a clock frequency higher than the sampling frequency of a first converter unit (32), turns off a field effect transistor (Q1) at the turn-off timing, and turns on a field effect transistor (Q2). A plurality of A/D converters (37a) are subjected to a multi-rate control, thereby to correct the threshold value of the predictor circuit (35) on the basis of the peak value of a lamp current (iOUT). Even if the peak values of current values (iQ1 and iQ2) are positioned for the sampling period of the first converter unit (32), the turn-off timings can be precisely set according to the current values (iQ1 and iQ2) without increasing the sampling frequency more than the necessary value. As a result, it is possible to improve the practicability and to control the lighting of a fluorescent lamp precisely.

The invention pertains to load control system and lighting system in an inverter circuit equipped with a switching device to activate load.

### BACKGROUND TECHNOLOGY

Originally, this type of load control system includes inverter part to convert a direct current into an alternating current, discharge lamps activated by the inverter part, detection part to detect current value and voltage value of the discharge lamps, A/D Converter to convert current value and voltage value of discharge lamp analog, calculation part to calculate standard value for control of the inverter part according to the digital amount detected by A/D Converter and lighting system equipped with control part to control the inverter part based on calculated standard value (For example, refer to Patent Document No. 1)

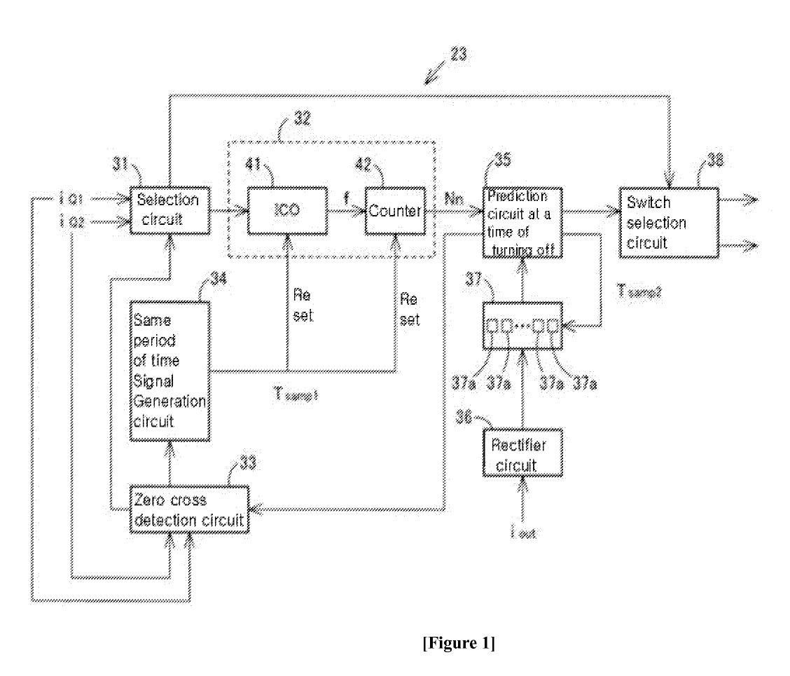

Patent Document No. 1: Public Patent Notification 10-41079 (Pages 3 to 4, FIG. 1)

### INITIATION OF THE INVENTION

### Invention Tasks

However, as 8-bit A/D Converter has 1 MHz to 2 MHz of sampling frequency, it is possible to record 0.5 μs to 1.0 μs in electrolysis, so it is impossible to sufficiently sample current value or voltage value in a switching device in the above-mentioned discharge lamp.

Accordingly, inverter part is controlled based on average value of each sampling, but it is difficult to accurately control the inverter part in the control.

In the meantime, it is possible to consider improving electrolysis capacity by using A/D Converter where sampling frequency is sufficiently increased compared to switching cycle or conducting multi-rate control by using multiple A/D Converters. However, in that case, consumption electric current is increased or becomes expensive and impractical.

The invention aims to provide load control system that can improve practicality and accuracy in addition to lighting system.

### Resolution

Inverter circuit equipped with switching elements driving load;

1^{st} conversion method which converts analogue current value passing through ‘On-state’ switching element into digital amount corresponding to the current value with current sampling frequency;

In the case that difference of digital amount between digital amount converted by certain timing from 1^{st} conversion method and next timing is less than minimum physical amount which generates certain reaction, and based on this difference, predicting method which predicts peak current value passing through switching element based on; and

Control method which turns off switching elements at the predicted timing by prediction method droved by higher frequency than sampling frequency for 1^{st} conversion method, and turns on switching element which was OFF; and

2^{nd} conversion method which converts amount of electricity from load into digital amount; and

Correction method which detects peak value of electricity coming from load by digital amount converted by 2^{nd} conversion method and based on this detection, corrects prediction of timing; and

Load control system equipped with above functions.

As for the inverter circuit, half-bridge type or full-bridge type is used.

As for the means of the 1^{st} conversion, a voltage control oscillator with 50 MHz of oscillation frequency or 8-bit flash type A/D Converter is used.

As for the means of prediction, DSP (Digital Signal Processor) is used.

As for the means of control, DSP is used, and although it is built in the means of prediction, repetition or separation from the means of prediction is allowed.

As for the means of the second conversion, multiple A/D Converters or a voltage control oscillator is used to conduct control at a multi-rate and convert the quantity of electricity generated from load into digital quantity at a larger sampling frequency than each sampling frequency.

As for the means of calibration, DSP is used, and although built-in installation is implemented together with the means of prediction or the means of control, repetition or separation from the means of prediction or the means of control is allowed.

While differences (time differences) between digital amount converted to certain timing by 1^{st} conversion method and next timing become less than minimum physical amount causing certain reaction, and based on variances of this difference, it predicts time when current flowing through switching elements is peak by predicting method, and control method which is driven by clock frequency higher than sampling frequency by 1^{st} conversion method turns off switching element which is ON for “Turn-Off” timing predicted by predicting method, and at the same time, and it turn on switching element which was Off, and it turns ON switching element which was OFF. In the mean time, it converts amount of electricity which is discharged into load by 2^{nd} conversion method into digital amount, and with this digital amount, it detects peak value of electricity which is coming from load, and based on this detection, variable setting method corrects timing for predicting method. As it timing for turning off is exactly set depending on value of current at switching element even though peak value of current passing through switching element exists between sampling frequencies for 1^{st} conversion method without having to increase sampling frequency excessively for 1^{st} conversion method. Therefore, it enhances productivity while it makes it possible to control load exactly.

Load control system in Claim 2 predicts the time when current value in a switching device peaks based on absolute quantity of digital converted by the 1^{st} means of conversion as it has the load control system in Claim 1, and as for the means of control, it turns off a switching device at the time expected by the means of prediction while turning on the switching device.

And by predicting the timing when value of current passing through switching elements is peak value with predicting method based on absolute amount of digital which is converted by 1^{st} conversion method and at the time of predicted timing, control method turns switching element off which was ON while it turns off switching element which was ON at the same time. Therefore these actions make it possible to turn off switching elements by reacting to peak value of current in switching elements along with variations of differences in digital amount converted from value of current passing through switching elements, even based on absolute amount of digital and consequently it's possible to more correctly control loads.

Load control system in Claim 3, Claim 1 or Claim 2, control method is to turn switching element off when rate for variations in differences increases as a predicting method.

And when rate of variations in differences has increases as a predicting mean, control method turns switching element off, which prevents abnormal circuits and over currents.

Lightening system described in Claim 4 is equipped with one load control system described either Claim 1 or Claim 3, and with mechanical body equipped with discharging lamp which is turned ON by this load control system.

And each function works by equipping with load control system described at either Claim 1 or Claim 3

### Effect of the Invention

According to load control system described at Claim 1, differences between digital amount which is converted at certain timing by 1^{st} conversion method and one at next timing after the previous timing becomes less than minimum physical amount. And based on this difference and by generating clock higher than sampling frequency in 1^{st} conversion method, it predicts the timing when switching element between sampling timing in 1^{st} conversion method is turned off, and at this predicted time, control method turns off switching element which was turned OFF and at the same time it turns on switching element which was turned OFF. In the mean time, amount of electricity which is coming from load by 2^{nd} conversion method is converted into amount of digital electricity, and this digital amount detects peak value for current which is discharged from load by 2^{nd} conversion method. And based on this detection, variable setting method corrects prediction for timing. As this can set ‘turn-off’ timing depending on value of current for switching element without having to increase sampling frequency in 1^{st} conversion method unnecessarily, which consequently increase practical use and makes it possible to control load exactly.

According load control system described at Claim 2, in addition to effects of load control system described at Claim 1, based on absolute amount of digital electricity which was converted by 1^{st} conversion method, predicting method predicts the timing when value of current passing through switching elements is peak, and at this predicted timing, control method turns off switching element which was turned OFF and at the same time, it turns on switching element which was turned OFF. Therefore this makes it possible to turn off switching element corresponding to peak value of current along with rate for variations in digital which was converted from current passing through switching element, even under absolute amount of digital, and consequently to control load more correctly.

Load control system described at Claim 3, it adds its effect to that of load control system described at either Claim 1 or Claim 2, in case that rate of variations in differences increased as prediction method, control method turns off switching elements, which prevents over currents due to abnormal circuits.

According lightening system described at Claim 4, its function works by equipping with one load control system described at either Claim 1 or Claim 3.

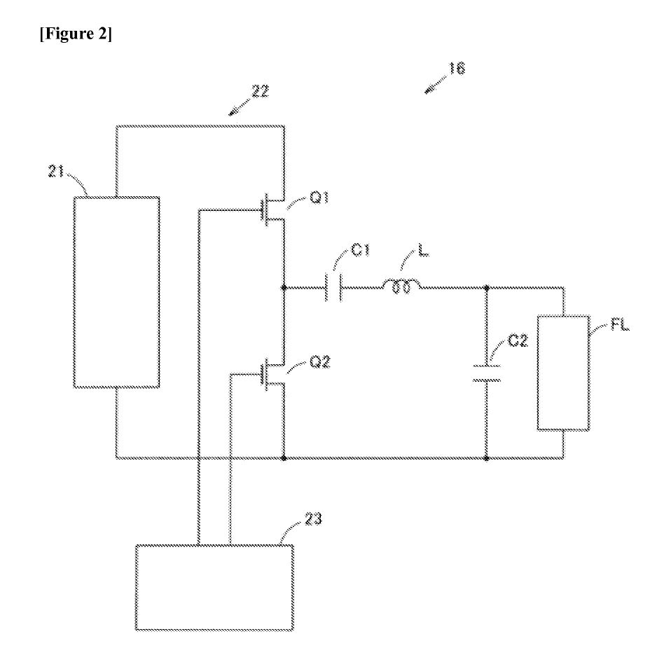

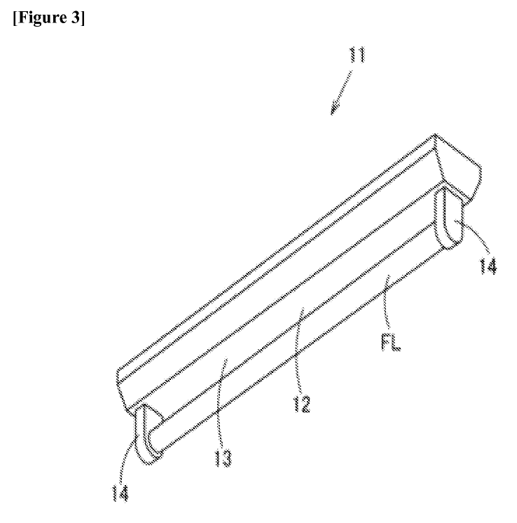

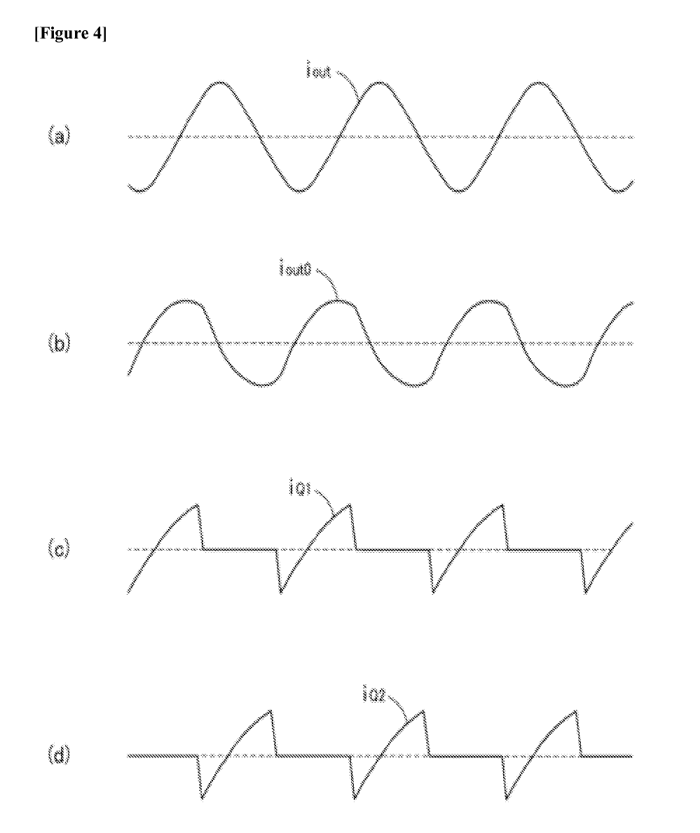

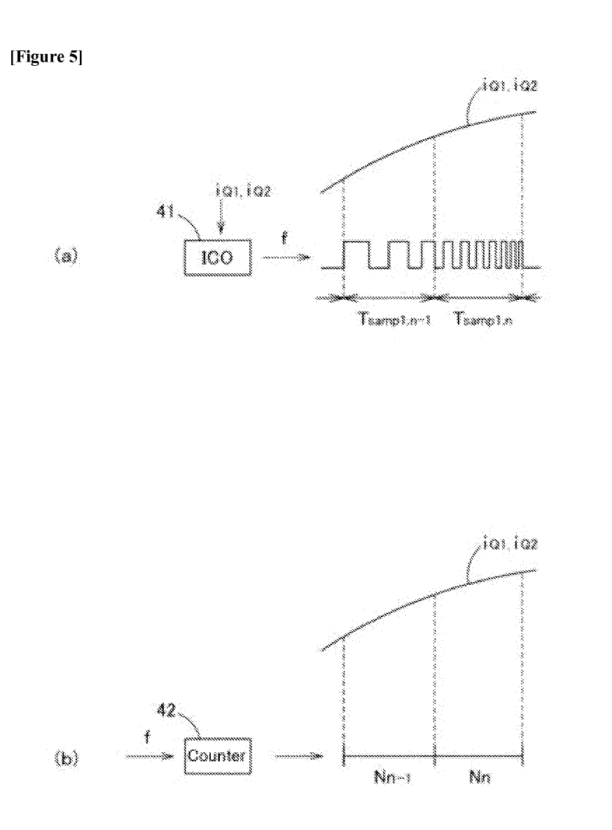

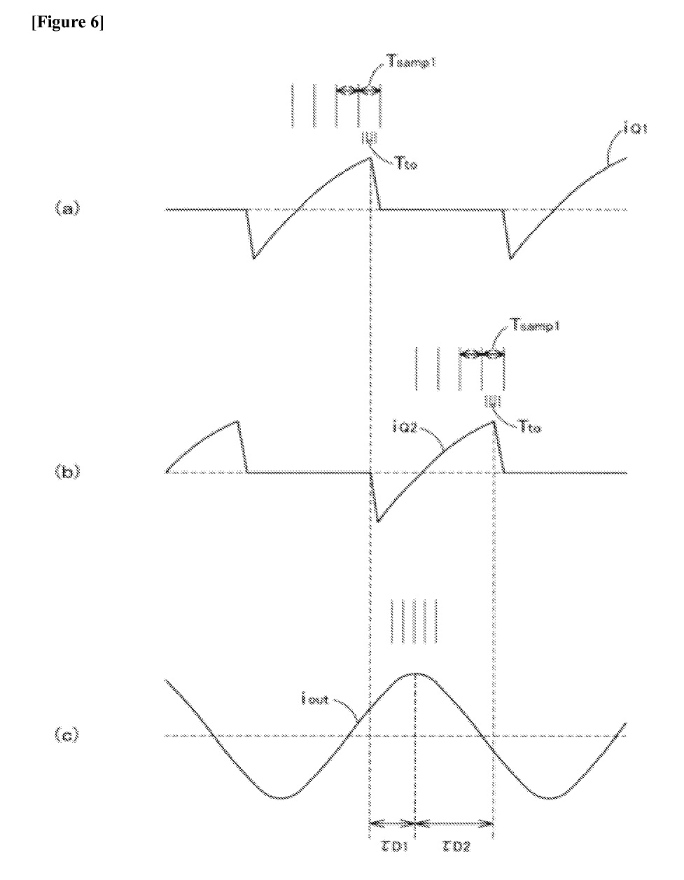

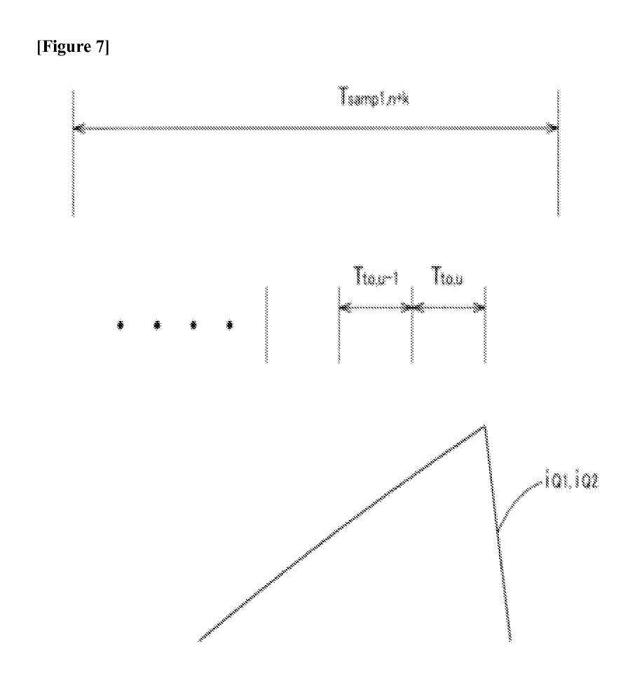

### BRIEF EXPLANATION ON DRAWINGS

[FIG. 1] Block diagram for some of load control system indicating characteristic after performing this invention one time

[FIG. 2] Circuit diagram for load control system mentioned above

[FIG. 3] Perspective view indicating lighting system equipped with load control system mentioned above

[FIG. 4] Graph indicating load of above load control system and amount of electricity for each switching element

[FIG. 5] Chart for explanation indicating operation of 1^{st} conversion method in above load control system.

[FIG. 6] Chart for explanation indicating detection algorithm for peak value of current in switching element of above load control system and peak value for electricity in load.

[FIG. 7] Chart for explanation enlarging some of detection algorithm for peak value of current in switching element of above load control system

### EXPLANATION ON SYMBOLS

11 Lighting system
12 The main body of the device
16 Discharge lamp lighting system as a load control device
22 Inverter circuit
32 The 1^{st} conversion part as the means of the first conversion
35 Turn-off prediction circuit with the means of prediction and calibration
37a A/D Converter as the means of the second conversion
38 Switch selection circuit as the means of control
Fluorescence lamp, a discharge lamp as FL load
Field effect transistor as Q1 and Q2 switching devices

### OPTIMIZED FEATURE TO CARRY OUT INVENTION

Below, feature for performing this invention will be explained by referring to drawing.

FIG. 1 shows block diagram for some of load control system, FIG. 2 shows circuit diagram for load control system, FIG. 3 is for perspective view showing contour of lighting system equipped with load control system, FIG. 4 is graph indicating load of load control system and amount of electricity in each switching element. FIG. 5 is chart for explanation indicating operation of 1^{st} conversion method in load control system. FIG. 6 is chart for explanation showing detection algorithm for peak value of current at switching element of load control system and peak value of electricity at load, and FIG. 7 is a enlarged explanation chart showing detection algorithm for peak value of current at switching element of load control system.

As shown in Picture 3, 11 is lighting system, and this lighting system 11 is equipped with mechanical body 12 and below this body 12 is formed reflection surface 13. Lamp socket 13 is equipped at both longer ends of reflection surface 13 and pipe-shaped fluorescence lamp FL, a discharging lamp as load, is electrically or mechanically equipped between lamp socket 14 and 14. Within mechanical body 12, equipment 13 which turns discharging lamp ON as load control system as shown in Picture 1 is applied.

As shown in Picture 2, inverter circuit 22, a circuit for turning on discharging lamp, is connected to DC power area which was rectified and leveled from commercial AC power 21 not shown. This inverter circuit 22 is a half bridge-shaped circuit in which field effect transistor (FET) Q1 and Q2 as a switching element is serial connected and inverter current iout0 (Picture 4(b)) is passing through.

In the mean time, digital control circuit 23 for digital controller as control circuit is connected to the gate for these field effect transistors Q1 and Q2

Serial circuits for condenser C1 for DC cut and inductor L1 is applied to connection point for field effect transistor (FET) Q1 and Q2 and connected to one end of fluorescence Lamp FL and one side of the fluorescence lamp FL not shown is connected to (south) negative pole of AC power area 21. Above it on fluorescence lamp FL is parallel connected starting-up condenser C2.

And as shown in Picture 1, digital control circuit 23 is connected to selection circuit 31 selecting electric current iQ1, iQ2 (Picture 4(c) and Picture 4(d)) passing through field effect transistor (FET) Q1 and Q2, and to 1^{st} converting area 32 as 1^{st} conversion method and zero cross detection circuit 33 and synchronization signal generation circuit 34. And at the same time, prediction circuit 35 (Hereafter called prediction circuit 35) is connected to 32 of 1^{st} conversion part when turning off with prediction method and correction method, and this prediction circuit 35 is connected to 2^{nd} conversion part 37 through rectifying circuit 36. In addition, prediction circuit 35 is connected to 2^{nd} conversion part 37 by rectifying circuit 36. In addition, electric current values, iQ1,iQ2 is called current value i for both ends.

Selection circuit 31 detects and selects parts through which current is passing among field effect transistor (FET) Q1 and Q2 and the selected current is discharged to 1^{st} conversion area 32. In addition, this selection circuit 31 can be configured in a way that it is forced to select either field effect transistor (FET) Q1 or Q2.

1^{st} conversion area 32, for example, is connected to current control oscillator (ICO) 4 (ICO) 41 as A/D converter and counter 42 as measuring method one by one.

Current control oscillator 41, when current i selected by selection circuit 31 is inputted, performs sampling for certain sampling frequency (Picture 5(a) and Picture 5(b)) which is sampling frequency of 1^{st} conversion area 32, i.e. by 50 MHz frequency and outputs clock signal f corresponding to current value i as a digital amount.

For example, this current control oscillator 41 outputs high frequency clock signal f when current is high. In addition, voltage control oscillator which generates clock signal f by sampling voltage converted by conversion method from current to voltage on behalf of current control oscillator 41 by converting current i into its voltage can be used.

Counter 42 is for counting clock signal f generated by current control oscillator 41 within certain period. Number of counts measured by the counter 42, for example if switching cycle for Field effect transistors Q1 and Q2 is 10 μs (switching frequency 100 kHz) and sampling frequency for current control oscillator 41 is 50 MHz and if time span Tsamp1 which is sampling cycle for synchronization signal generation circuit 34 is 0.1 μs (sampling frequency is 10 MHz), is possible to take around 5, and around 10 if time span Tsamp1, for example is 0.2 μs (sampling frequency is 5 MHz), and around 50 when time span Tsamp1 is 1.0 μs (sampling frequency is 1 MHz). And counter 42 outputs count number Nn into prediction circuit 35 which is average value for each time span Tsamp1 by n intervals.

Zero cross detection circuit 33 detects zero cross point for current i (point changed correctly at edge) and outputs this detected timing to signal generating circuit 34 during same period, and this output resets counter 42 for current control oscillator 41 and starting timing by same period of signal for each time span Tsamp1 generated by signal generation circuit 34 of same period, and it makes it possible to equalize sampling frequency of 1^{st} converting part 32 at cross point of current i.

In other word, sampling frequency for 1^{st} conversion area 32 is same as that of inverter circuit 22 (Picture 2). In addition, sampling frequency for 1^{st} conversion area 32 doesn't necessarily need to be same as that of inverter circuit 22 (Picture 2). In this case, zero cross detection circuit 33 doesn't necessarily need to be made.

Prediction circuit 35 becomes less than minimum physical amount NDREF to extent which difference ND=Nn−Nn−1 between counter number Nn converted at certain timing by 1^{st} conversion area 32 and next timing counter Nn reacts, and based on rate of variations in difference ND i.e. NDD,n=ND,n−ND,n−1,NDD,n−1=ND,n−1−ND,n−2, . . . , NDD,n−v=ND,n−v−ND,n−v−1, it is possible to predict the timing when one of current values iQ1 and iQ2 from field effect transistors Q1 and Q2 (Picture 6(a) and Picture 6(b)). In addition, this prediction circuit 35 depends on absolute digital amount to each time span Tsamp1, k(k=1, 2, . . . , n−1,n, . . . ) i.e. plural number of each count number Nk(k=1, 2, . . . , n−1, n, . . . ) and it makes it possible to predict the timing when one of current value iQ1 or iQ2 is peak.

Rectifying circuit 36 rectifies electricity of fluorescence lamp FL by wave rectification, i.e. DC lamp current which is output current and outputs the rectified one into 2^{nd} conversion area 37. In addition, output current or electric power, for example, is good as electricity FL of fluorescence lamp

2^{nd} conversion area 37 equipped with plural number of 2^{nd} converting method, A/D converter 37a inside converts fluorescence lamp current iout generated from rectifying circuit 36 into digital amount by A/D converting by controlling A/D converter 37a. i.e. by slackening each phase to a certain level (Picture 6(c)). Therefore, the 2^{nd} conversion area 37 carries out sampling by higher sampling frequency than that of A/D converter 37ai.e. with lower time span Tsamp2 than sampling time span of A/D converter 37a. In addition, 2^{nd} conversion area 35 receives sampling timing from prediction circuit 35.

In addition, 2^{nd} conversion 37, if it is possible to compare with standard analogue amount, and to correct temperature, can substitute each A/D converter 37a and can be configured in a way that a pair of voltage control oscillator and counter is composed, or only A/D converter 37a can be used.

And switch selection circuit 38 is connected to each gate for field effect transistors Q1 and Q2 and controls switching at the time which is predicted by prediction circuit 35. Switch selection circuit 38 usually controls field effect transistors Q1 and Q2 by around 100 kHz of switching frequency (10 μs of switching cycle)

Following is a example for one cycle of operation mentioned above

Field effect transistors Q1 and Q2 is switch controlled by digital control circuit 23, and high frequency voltage discharged from inverter circuit 22 is converted to resonance voltage of DC cut condenser C1, inductor L and starting condenser C2 and this resonance voltage pre-heats filament of fluorescence lamp FL and turn on fluorescence lamp FL.

Here in this digital circuit 23 detects, zero cross detection circuit 33 detects the timing current value of iQ1 is actual, and this zero cross detection signal is inputted to selection circuit 31 and the selection circuit 31 selects current value, iQ1, and the selected current value iQ1 is converted to clock signal f corresponding to absolute amount of current by current control oscillator 41, and the converted clock signal f is counted by counter 42.

In this case, zero cross detection signal from zero cross detection circuit 33 is inputted to synchronization signal generation circuit 34, and operation timing with counter 42 is reset to current control oscillator 41, and sampling cycle of current control oscillator 41 (1^{st} conversion area 32) is synchronized with switching cycle of inverter circuit 22.

And next, if counting number Nn for each time span Tsamp1, n(n=1, 2, . . . ) is inputted to prediction circuit 35 by counter 42, this prediction circuit 35 calculates differences ND, n based on counting number Nn. And it predicts when differences ND, n is less than minimum physical amount NDREF which has generated certain reaction, i.e. when ND,n≦NDREF, predicts ‘turn-off’ timing Tto,u for Field effect transistor Q1.

More specifically, prediction circuit 35 calculates differences NDD, i.e. NDD,n=ND,n−ND,n−1,NDD,n−1=ND,n−1−ND,n−2, . . . , NDD,n−v−1=ND,n−v−ND,n−v−1, and based on this variation, it generates higher clock frequency than sampling frequency of 1^{st} conversion area 32, and predicts peak timing of current value iQ1 located at time span Tsamp1 after sampling cycle for k number, i.e. Tto which is shorter time span than time span Tsamp1 (Picture 7)

Here, if variation of differences NDD is getting lowered, assuming that it is more and more approaching to peak value, and if the difference NDD is less than certain value, it assumes that the value is peak value. In addition, although k is usually set to 1 or 2, for example if minimum physical amount NDREF is insufficient for setting dissolution, it's possible to supplement insufficiency of setting dissolution by enlarging k.

For example, including case that above mentioned timing Tto,u is predicted within area which is not varied for slope of current passing through field effect transistor Q1 and if it is impossible to predict timing, Tto,u as switching frequency of field effect transistor Q1 and Q2 I is varied to a large extent, prediction circuit 35, based on absolute amount of pair of counting number Nn, predicts the timing when current value iQ1 is peak. In addition, targeted peak value for current value i is set by difference between lamp current iout and its targeted value.

And by timing Tto,u which is predicted by prediction circuit 35, this prediction circuit 35 controls switch selection circuit 38 with tiny with PWM signal in time span Tto, and this switch selection circuit 38 turned off Field effect transistor Q1 which is field effect transistor selected current value i by selection circuit 31 in this case, and it also turns off timing Tto,u that is predicted by prediction circuit 35, and subsequently it turns on Field effect transistor Q2 by timing T1 or Timing T2

In the mean time, lamp current iout is rectified by rectifying circuit 36 and each A/ converter 37a of 2^{nd} conversion area 37 is controlled by multi-rate, and it is converted to digital amount corresponding to certain time span Tsamp2 after time, τD1 from timing Tto,u

And prediction circuit 35 detects peak value for lamp current, iout by converted digital amount, and based on this detection, it suitably corrects minimum reacting physical amount, NDREF.

In this case, digital amount of 2^{nd} conversion area 37 which is used to correct minimum physical reacting amount, NDREF, for example, it uses average of digital amount converted by each A/D converter, 37a if time span Tsamp2 is relatively short, and it uses maximum or minimum value of digital amount converted by each A/D converter, 37a if time span, Tsamp2 is relatively long.

As the result, this corrected timing. i.e. by the time delayed from detection timing for peak value of lamp current iout to time, τD2, field effect transistor Q2 is turned off same as ‘turn off control’ of Field effect transistor Q1 mentioned above, and then Field effect transistor Q1 is turned ON. In other words, ‘turn-off timing’ (PWM signal output) after half cycle of switching cycle for Field effect transistor Q1 and Q2

After that, control for Field effect transistor Q1 and Q2 is repeated alternatively by same procedure mentioned above.

As mentioned above, on condition that difference between the counting number, Nn−1 converted by 1^{st} conversion area 32 and the next counting number Nn becomes less than minimum physical amount, NDREF which generates certain level of reaction, and based on this difference, ND, it predicts the timing, Tto,u when current values, iQ1,iQ2 passing through Field effect transistor Q1,Q2 reached at peak, and at this predicted ‘turn-off’ timing Tto,u, the switch selection circuit 38 turns off Field effect transistor which was ON, i.e. Field effect transistor Q1, and at the same time, it turns on Field effect transistor Q1 which was ON.

In the mean time, by controlling plural number of A/D converter 37a with multi-rate near by ‘turn-off’ timing, Tto,u predicted by prediction circuit 35, and it converts lamp current iout into digital amount, and by this digital amount, it detects peak value of lamp current iout, and based on this detection, it corrects the prediction of timing for prediction circuit 35, and more specifically correcting minimum physical amount, NDREF which generated reactions. This algorithm is able to set ‘turn-off’ timing, Tto,u exactly without having to enlarge sampling frequency for 1^{st} conversion area 32 although peak value, i exists between sample cycle for 1^{st} conversion area 32. Therefore, it enhances practical use and controls fluorescence LAMP FL for ON and OFF.

In addition, based on absolute amount of counting number, Nn converted by 1^{st} conversion area 32, prediction circuit 35 predicts the timing when current value, i reached at its peak value, and at this predicted timing, switch selection circuit 38 turns off field effect transistor which was ON, here, field effect transistor Q1 and at the same time, it turns on field effect transistor which was OFF, here, field effect transistor Q2. As it is possible to turn off field effect transistor, here referred to field effect transistor Q1 along with varying rate for difference, ND for counting number, Nn by corresponding to peak value i of current even based on absolute amount of current i. Therefore it is able to control load more correctly.

Moreover, by predicting the timing, Tto,u when current, i reaches at peak value based on calculated result for difference, ND of counting number Nn before several cycles of time span Tsamp1 which is peak, it is able to acquire calculation time.

And as current values of field effect transistors Q1,Q2 near by input for device of turning discharge lamp on sets ‘turn-off’ timing, its response is good. Especially as fluorescence lamp FL is vulnerable to be turned off or blinking if response is slow at lighting system 11, it is able to prevent this turning off or blinking by enhancing response ability.

In addition, in usual case, when rate for difference, ND is increasing for reducing prediction circuit 35, switch selection circuit 38 turns off field effect transistor Q1 or Q2, therefore it prevents over current due to malfunction of circuits from field effect transistor Q1 or Q2

In addition, in case of one cycle for above procedure, it's also possible to control lamp current iout every single cycle by controlling only one of field effect transistor Q1 or Q2. In this case, it's easier and desirable to control field effect transistor Q2.

In addition, for setting ‘turn-off’ timing mentioned above, it's recommended that its ‘turn-off’ timing is carried out for each cycle during transition time for device 11 of discharge lamp, and for several cycle during stabilized period.

Moreover, 1^{st} conversion area 32 has same functions as current control oscillator 41 and counter 42. For example, it's possible to use 8 bit flash-typed A/D converter.In this case, for example, it's possible to use either A/D converter 37a of 2^{nd} conversion area 37, or 37a of A/D converter of 2^{nd} conversion area 3

And in electrical amount in load, for example, output current or power besides output current such as lamp current iout are possible to be controlled as procedure mentioned above.

In addition, correction method substitute correction of minimum physical amount, NDREF which generates reaction, and it's also possible to control by varying k value of time span, Tsamp1,n+k or use both of them simultaneously.

And for controlling fluorescence lamp FL, above load control system can be used.

Feasibility for Commercial Purposes

This invention is used for home lighting system and others

1. A load control device comprising:
an inverter circuit equipped with the switching elements driving load;
1st conversion device which converts analogue current value passing through ‘on-state’ switching element into digital amount corresponding to the current value with current sampling frequency;
predicting device which the predicts timing that the value of current passing through switching element reaches the peak, under the difference between digital amount converted according to prescribed timing by the first conversion device and digital amount of the following timing of the timing is below a prescribed threshold;
the control device which turns off the switching elements at the predicted timing by the prediction device droved by higher frequency than sampling frequency for the 1st conversion device, and turns on the switching element which was ‘off-state’;
2nd conversion device which converts amount of electricity from load into digital amount; and
the correction device which detects peak value of electricity coming from load by digital amount converted by the 2nd conversion device and based on this detection, corrects prediction of timing.

2. The load control device comprising of claim 1, wherein said prediction device predicts the timing when current value passing through the switching elements reaches at its peak, based on absolute amount of digital converted by 1st conversion device,
said control device turns off switching element under on-state at the predicted timing, and turns on switching element under off-state.

3. The load control device comprising of claim 1, wherein said control device turns off switching element when said predicting device sensed the increasing of the difference.

4. A lighting device comprising:
the load control device described of claim 1; and
mechanical body which is equipped with discharge lamp which is turned on by this load control device.

5. A lighting device comprising:
the load control device described of claim 2; and
mechanical body which is equipped with discharge lamp which is turned on by this load control device.

6. A lighting device comprising:
the load control device described of claim 3; and
mechanical body which is equipped with discharge lamp which is turned on by this load control device.
